(19) United States
(12) Patent Application Publication
(10) Pub. No.: US 2019/0286984 A1
(43) Pub. Date: Sep. 19, 2019

(54) NEURAL ARCHITECTURE SEARCH BY PROXY

(71) Applicant: Google LLC, Mountain View, CA (US)

(72) Inventors: Vijay Vasudevan, Los Altos Hills, CA (US); Mohammad Norouzi, Sunnyvale, CA (US); George Edward Dahl, Sunnyvale, CA (US); Manoj Kumar Sivaraj, Palo Alto, CA (US)

(73) Assignee: Google LLC, Mountain View, CA (US)

(21) Appl. No.: 16/351,104

(22) Filed: Mar. 12, 2019

Related U.S. Application Data
(60) Provisional application No. 62/642,496, filed on Mar. 13, 2018.

(51) Int. Cl. G06N 3/08; G06N 3/04

(52) U.S. Cl. CPC G06N 3/08; G06N 3/04

(57) ABSTRACT

A method of determining a final architecture for a neural network (NN) for performing a particular NN task is described. The method includes: maintaining a sequence of classifiers, wherein each classifier has been trained to process an input candidate architecture and to assign a score label to the input candidate architecture that defines whether the input candidate architecture is accepted or rejected from further consideration; repeatedly performing the following operations: sampling, from a search space, a batch of candidate architectures; for each candidate architecture: determining whether the candidate architecture is accepted by all of the classifiers in the sequence of classifiers; in response to a determination that the candidate architecture is accepted by all classifiers, adding the candidate architecture to a surviving set of candidate architectures; and selecting a candidate architecture from the surviving set as the final architecture for the neural network for performing the particular NN task.

### CROSS REFERENCE TO RELATED APPLICATIONS

This application is a non-provisional of and claims priority to U.S. Provisional Patent Application No. 62/642,496, filed on Mar. 13, 2018, the entire contents of which are hereby incorporated by reference.

### BACKGROUND

This specification relates to determining architectures for neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes a system implemented as computer programs on one or more computers in one or more locations that determines, using a sequence of classifiers, an architecture for a neural network that is configured to perform a particular neural network task.

The subject matter described in this specification can be implemented in particular embodiments so as to realize one or more of the following advantages. The architecture search techniques described in this specification require less computational resources and time than existing approaches, while still determining high-performing model architectures. In particular, by constructing a short list of architectures using a proxy performance metric that evaluates the performance of the architectures on a cheaper proxy task, and then selecting the best architecture from the list on the real task, the network architecture search engine described in this specification can speed up the search on the real task while using less computational resources. In addition, the architecture search techniques described herein maintain a high degree of diversity among the candidate architectures generated while using more information from proxy measurements than conventional methods, e.g., methods that use completely random search, thereby being able to determine effective architectures that result in high-performing neural networks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network architecture search (NAS) system.

FIG. 2 is a flow diagram of an example process for determining a final architecture for a neural network for performing a particular neural network task.

FIG. 3 is a flow diagram of an example process for training a new classifier.

Like reference numbers and designations in the various drawings indicate like elements.

### DETAILED DESCRIPTION

This specification describes a neural network architecture search system implemented as computer programs on one or more computers in one or more locations that determines, using a sequence of classifiers, an architecture for a task neural network that is configured to perform a particular neural network task. Depending on the task, the neural network can be configured to receive any kind of digital data input and to generate any kind of score, classification, or regression output based on the input.

For example, if the inputs to the neural network are images or features that have been extracted from images, the output generated by the neural network for a given image may be scores for each of a set of object categories, with each score representing an estimated likelihood that the image contains an image of an object belonging to the category.

As another example, if the inputs to the neural network are Internet resources (e.g., web pages), documents, or portions of documents or features extracted from Internet resources, documents, or portions of documents, the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, if the input to the neural network is a sequence representing a spoken utterance, the output generated by the neural network may be a score for each of a set of pieces of text, each score representing an estimated likelihood that the piece of text is the correct transcript for the utterance.

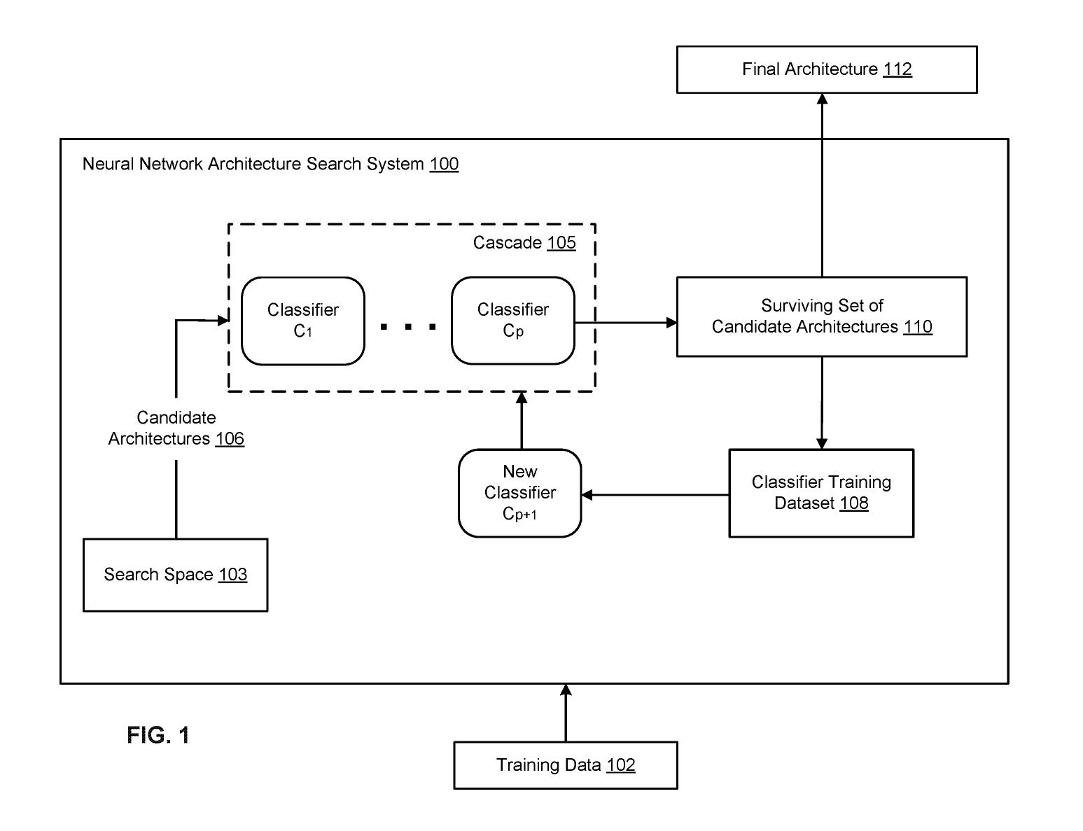

FIG. 1 shows an example neural network architecture search (NAS) system 100 that is configured to determine a final architecture for a neural network for performing a particular neural network task. The NAS system 100 is an example of a system implemented as computer programs on one or more computers in one or more locations, in which the systems, components, and techniques described below can be implemented.

The NAS system 100 is configured to receive, e.g., from a user of the system, training data 102 that includes a first training dataset for training a neural network to perform the particular neural network task (also referred to as the “real neural network task” or the “real task”). The first training dataset includes multiple training examples and a respective target output for each training example. The target output for a given training example is the output that should be generated by the trained neural network by processing the given training example. The system 100 can divide the first training dataset into a training subset, a validation subset, and, optionally, a test subset.

The training data 102 further includes a proxy training dataset for training a neural network to perform a proxy task that is correlated with the particular neural network task. The proxy task is computationally less expensive than the particular neural network task. That is, less computational resources are required to perform the proxy task or to train a neural network on the proxy task than the real neural network task. For example, the real task may be performance of a particular neural network on a held-out validation set after the particular neural network has been trained on a full training set, while a proxy task may be performance of the particular neural network on a different validation set after the particular neural network has been trained on a smaller subset of the training set. As another example, a real task may be a yield of a manufacturing process when running in a real manufacturing plant as a function of certain control inputs, while a proxy task may be a simulated yield based on a simulation of the manufacturing process. As yet another example, the real task may be performance of a particular neural network when handling real data (e.g. web traffic) and after a learning rate for training the particular neural network has been tuned, while a proxy task may be performance of the particular neural network when handling historical data and without a carefully tuned learning rate.

The proxy training dataset includes multiple proxy training examples and a respective proxy target output for each proxy training example. The proxy target output for a given proxy training example is the output that should be generated by the trained neural network by processing the given proxy training example. The system 100 can divide the proxy training dataset into a proxy training subset, a proxy validation subset, and, optionally, a proxy test subset.

The system 100 can receive the training data 102 in any of a variety of ways. For example, the system 100 can receive training data as an upload from a remote user of the system over a data communication network, e.g., using an application programming interface (API) made available by the system 100. As another example, the system 100 can receive an input from a user specifying which data that is already maintained by the system 100 should be used as the training data 102.

To search for the final architecture in a computationally efficient manner, the system 100 maintains a cascade ofp classifiers (105). Thep classifiers can be denoted as c₁(x), c₂(x), . . . cₚ(x), where x denotes an input candidate architecture. Each classifier in the cascade 105 is a machine learning model that has been trained to process an input candidate architecture x and to assign a score label cᵢ(x) to the input candidate architecture x. The score label defines whether the input candidate architecture is accepted or rejected from further consideration by the classifier. The score label assigned to the input candidate architecture is a prediction of how well the input candidate architecture would perform on the proxy task. If the score label assigned to the input candidate architecture exceeds a threshold (e.g., the input candidate architecture would likely perform well on the proxy task), the input candidate architecture is accepted by the classifier for further consideration. If the score label does not exceed the threshold (e.g., the input candidate architecture would likely not perform well on the proxy task), the input candidate architecture is rejected by the classifier from further consideration. For example, the score label assigned to an input candidate architecture x by any given classifier i can be a binary label, e.g., cᵢ(x)∈{−1,1}. If cᵢ(x)=−1, the input candidate architecture x is rejected by classifier i. If cᵢ(x)=1, the input candidate architecture x is accepted by classifier i. In this example, the threshold can be, e.g., zero. As another example, the score label assigned to an input candidate architecture can be a value in the range of [−1,1], i.e., negative one to one, inclusive. In this example, the threshold can also be zero. As yet another example, the score label assigned to an input candidate architecture can be a probability, e.g., a value in the range of [0,1]. In this example, the threshold can be 0.5.

To find the final architecture for the task neural network for performing the real neural network task, the system 100 repeatedly performs an iterative search procedure. At each iteration of the search procedure, the system 100 samples from a search space 103 a batch of candidate architectures 106 for the neural network. For example, the system 100 can randomly sample the batch of the candidate architectures 106 in accordance to a probability distribution. For example, the probability distribution is a uniform distribution.

To sample a candidate architecture from the search space 103, the system 100 samples convolutional building blocks of a cell that is repeated throughout the candidate architecture. In particular, the system 100 samples hyperparameter values for generating each of the convolutional building blocks. For example, to generate a convolutional building block b of the cell, the system 100 samples 4 hyperparameter values, (I₁, I₂, O₁, O₂), where I₁, I₂∈ [symbol] _{b} specifies the input hidden states for block b; O₁, O₂∈ [symbol] specifies the operations to apply to the input hidden states I₁ and I₂, respectively, where [symbol] is an operation space. The set of possible input hidden states, [symbol] _{b}, is the set of all previous blocks in the cell 200, plus the output of the previous cell, plus the output of the cell preceding the previous cell. The operation space [symbol] may include, but not be limited to, the following operations: identity, 1×7 followed by 7×1 convolution, 3×3 average pooling, 1×1 convolution, 3×3 depthwise-separable convolution, 5×5 depthwise-separable convolution, 7×7 depthwise-separable convolution, 1×3 followed by 3×1 convolution, 3×3 dilated convolution, 3×3 max pooling, and 3×3 convolution. The system 100 can combine the two input hidden states by adding them.

For each candidate architecture in the batch, the system 100 uses the cascade of classifiers 105 to determine whether to reject or accept the candidate architecture. If the candidate architecture is rejected by one of the classifiers in the cascade 105, the system 100 rejects the candidate architecture. If the candidate architecture is accepted by all of the classifiers in the cascade 105, the system 100 adds the candidate architecture to a surviving set of candidate architectures 110. For example, given a candidate architecture x, if there exists a classifier i in the cascade 110 with i∈{1, . . . , p} such that cᵢ(x)=−1, then the system 100 rejects the candidate architecture x. Once the candidate architecture x is rejected by one of the classifiers in the cascade 105, the candidate architecture x is no longer processed by the other classifiers in higher levels of the cascade 105, thus saving computational costs. If cᵢ(x)=1 with ∀i ∈{1, . . . , p}, then the system 100 accepts the candidate architecture x and adds x to the surviving set 110. Given p binary classifiers in the cascade 105 that on average reject 50% of the candidate architectures in the batch, this procedure amounts to accepting a volume of about ½^{p} of the search space 103.

Once the batch of candidate architectures 106 have been evaluated by the cascade of classifiers 105, the system 100 determines if the current number of classifiers in the cascade 105 has reached a maximum number of P classifiers allowed in the cascade 105. For example, P can be 15, 18, 20, or 25. If P has not been reached, the system 100 initializes a new (p+1)^{th} classifier. The (p+1)^{th} classifier can be denoted as cₚ₊₁(x). The system 100 then prepares to train the new classifier by determining, for each candidate architecture in the surviving set of candidate architectures 110, a respective proxy performance metric of the candidate architecture on the proxy task. Because the proxy task is correlated to the real neural network task, the respective proxy performance metric of the candidate architecture on the proxy task approximates a performance metric of the candidate architecture on the real neural network task.

The system 100 can determine a proxy performance metric of a given candidate architecture on the proxy task using the proxy training dataset in the training data 102. Specifically, using the proxy training dataset, the system 100 can train a neural network having the given candidate architecture on the proxy task and then evaluate performance of the trained neural network on the proxy task to determine a performance metric for the given candidate architecture on the proxy validation set. For example, the performance metric can represent a level of accuracy of candidate architecture on the proxy validation set. The system 100 then determines, based on the proxy performance metrics of the candidate architectures, a respective score label for each candidate architecture in the surviving set of candidate architectures 110.

For example, the system 100 can determine a median value of the proxy performance metrics of all candidate architectures in the surviving set 110. The system 100 can assign a positive label (+1) to candidate architectures that have proxy performance metrics equal to or above the median value and assign a negative label (−1) to candidate architectures that have proxy performance metrics below the median value.

In some implementations, to ensure that classifiers with low-accuracy are not used, before training the new classifier, the system 100 determines a respective k-fold cross validation accuracy for each of k independent classifiers (i.e., classifiers that are only used for computing k-fold cross validation accuracy) on the classifier training dataset 108 (also referred to as “dataset T” for simplicity). In particular, the system 100 divides dataset T into k equal validation subsets (V₁, V₂, . . . , Vₖ). For each validation subset Vₜ, the system 100 trains a respective independent classifier C′ₜ on the dataset T excluding Vₜ and computes a respective k-fold cross validation accuracy Aₜ for the independent classifier C′ₜ on the validation subset Vₜ. The system 100 then determines a mean k-fold cross validation accuracy of k classifiers by computing a mean value of (A₁, A₂, . . . , Aₖ). The system 110 determines whether the mean k-fold cross validation accuracy of the k independent classifiers exceeds an accuracy threshold. The system only trains the new classifier on the entire dataset T when the mean k-fold cross validation accuracy of the k classifiers exceeds the accuracy threshold. For example, the system only trains the new classifier if the mean 5-fold cross validation accuracy of 5 independent classifiers on the dataset T is at least 0.5.

If the mean value does not exceed the accuracy threshold, the system 100 stores the dataset T. When a new batch of surviving candidate architectures arrives, the system 100 adds the new surviving candidate architectures and their respective score labels to the dataset T and performs the same procedure above. By checking the cross validation accuracy of the independent classifiers before deciding to add a new classifier to the cascade in this manner, the system 100 ensures that the trained classifier that is added to the cascade will be able to accurately predict score labels for new candidate architectures.

When the mean k-fold cross validation accuracy of the k classifiers exceeds the accuracy threshold, the system 100 trains the new classifier cₚ₊₁(x) on a classifier training dataset 108 that includes: (i) the surviving set of candidate architectures 110, and (ii) a respective score label assigned to each candidate architecture in the surviving set 110 to generate score labels that match the respective score labels for the architectures in the classifier training set. In some implementations, the system 100 is a gradient boosted tree classifier and the system 100 trains the new classifier using the gradient boosted trees training method. Gradient boosted trees have shown to be flexible, fast for both training and inference, robust to the choice to their own hyperparameters, and easy to get working in new problem domains. The gradient boosted trees method is described in detail in T. Chen and C. Guestrin. Xgboost, “A scalable tree boosting system,” KDD, 2016 and J. H. Friedman “Greedy function approximation: a gradient boosting machine,” Annals of statistics, 2001.

In some other implementations, the new classifier is a random forest classifier and the system 100 trains the new classifier using a random forests method. The random forests method is described in detail in A. Liaw, M. Wiener, et al., “Classification and regression by randomforest,” R news, 2 (3):18-22, 2002.

Once the new (p+1)^{th} classifier has been trained, the system 100 adds the new classifier to the cascade of classifiers 105 as the final classifier. The new classifier is used along with the previous classifiers in the cascade 105 to evaluate the next batch of candidate architectures. The system 100 resets the surviving set of architectures 110 to null only if the number of classifiers in the cascade 105 is less than the maximum number of P.

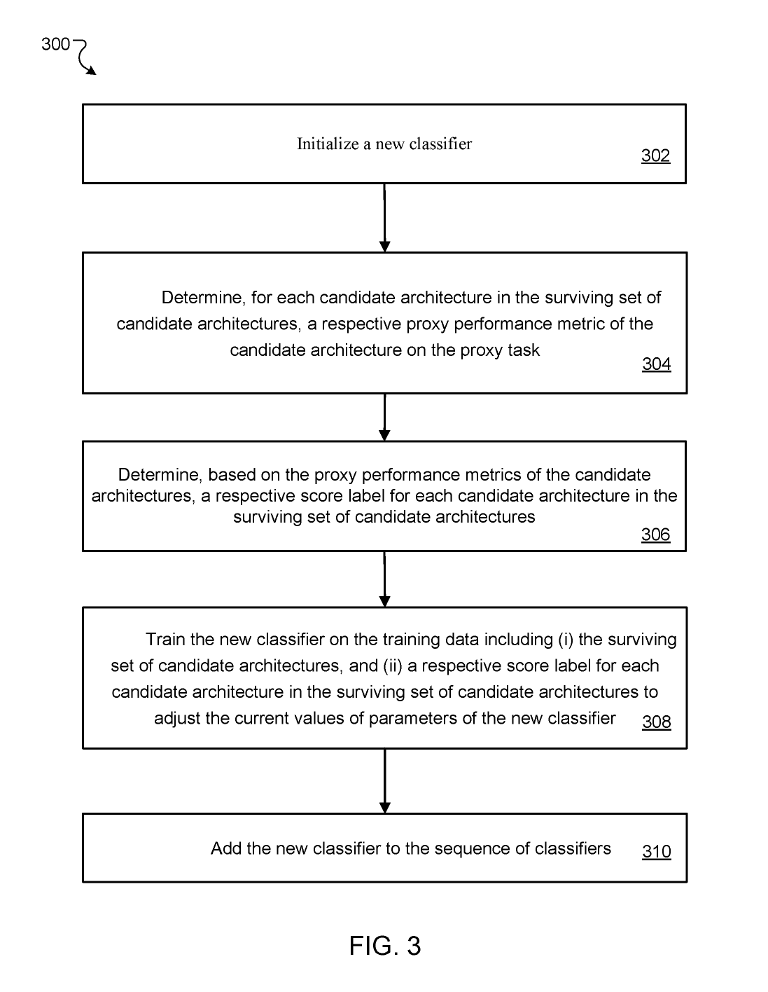

The process for training a new classifier is described in more detail below with reference to FIG. 3.

The system 100 repeats the above search procedure including sampling a batch of candidate architectures, evaluating the candidate architectures in the batch using the current classifiers in the cascade 105, adding surviving candidate architectures to the surviving sets, and training and adding a new classifier to the cascade 105 until the maximum number of P classifiers allowed in the cascade 105 is reached. After P classifiers have been trained and added to the cascade 105, the system 100 keeps the cascade 105 fixed and uses the cascade 105 to evaluate newly sampled candidate architectures until the number of candidate architectures sampled from the search space and evaluated by the cascade 105 reaches a predetermined threshold number B (also referred to as the “budget of B proxy evaluations”). For example, B can be 200, 400, 1600, or 8000.

In some implementations, to accelerate the search process, a parallel budget of W workers can be used for evaluating candidate architectures. To accommodate the parallel budget of W workers, the system 100 can only train the new classifier on the training data when the number of candidate architectures in the surviving set 110 exceeds a minimum number of architectures T_{c}. The minimum number of architectures T_{c} can be defined by

$${T}_{c} = W [ \frac{B}{W ( K + 1 )} ] .$$

For instance, given a budget of B=8000 proxy evaluations, K=18 classifiers, and W=100 workers, the minimum number of architectures T_{c} is 421.

After the budget of B proxy evaluations expires, the system 110 constructs a short list of candidate architectures for the real task by selecting, from the surviving set of candidate architectures 110, top N candidate architectures that have the highest proxy performance metrics on the proxy task. The system 110 determines, for each of the N candidate architectures, a respective performance metric of the candidate architecture on the real neural network task. The system 100 can determine a performance metric of each of the N candidate architectures on the real task using the first training dataset in the training data 102. Specifically, using the first training dataset, the system 100 can train a neural network having a given candidate architecture on the real task and then evaluate performance of the trained neural network on the real task to determine a performance metric of the given candidate architecture.

The system 100 then selects the candidate architecture having a highest performance metric on the real neural network task as the final architecture 112 for the task neural network.

By constructing a short list of candidate architectures using proxy performance metrics that evaluates the performance of candidate architectures on the cheaper proxy task, and then selecting the best architecture from the list for the real task, the network architecture search system 100 can speed up the search on the real task while using less computational resources. In addition, the system 100 can maintain a high degree of diversity among the surviving candidate architectures while using more information from proxy measurements than conventional methods, e.g., methods that use completely random search, thereby being able to determine an effective final architecture that result in a high-performing neural network.

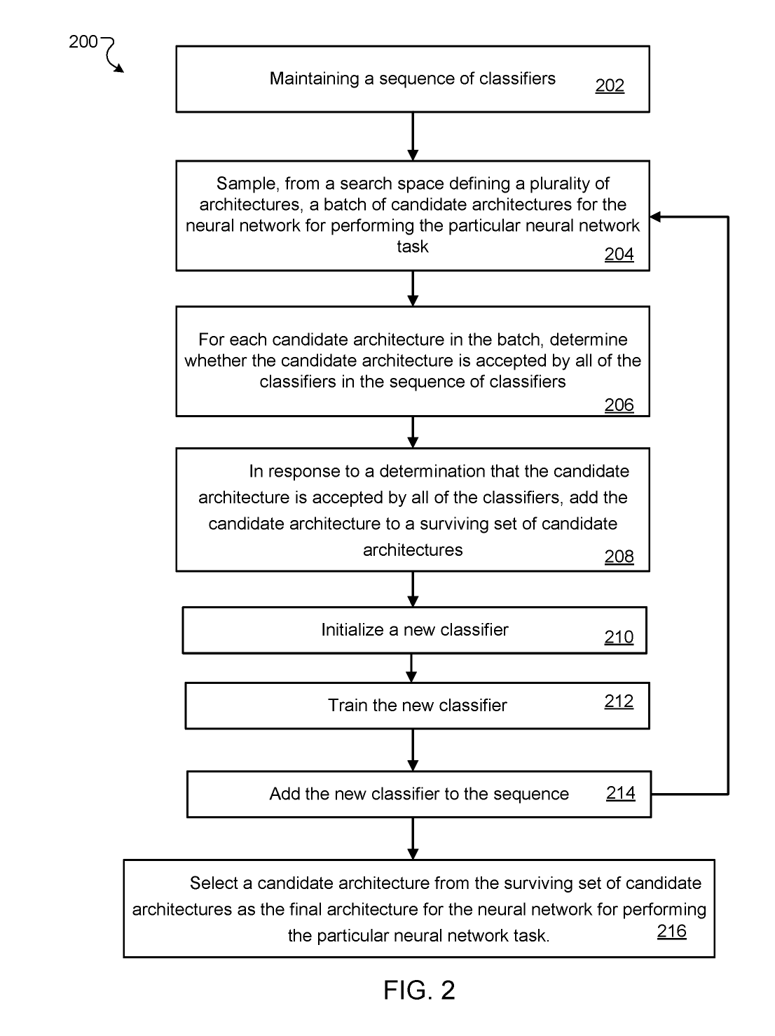

FIG. 2 is a flow diagram of an example process for determining a final architecture for a neural network for performing a particular neural network task. For convenience, the process 200 will be described as being performed by a system of one or more computers located in one or more locations. For example, a neural network architecture search system, e.g., the neural network architecture search system 100 of FIG. 1, appropriately programmed in accordance with this specification, can perform the process 200.

The system maintains a sequence of classifiers (step 202). Each classifier in the sequence is a machine learning model that has been trained to process an input candidate architecture and to assign a score label to the input candidate architecture. The score label defines whether the input candidate architecture is accepted or rejected by the classifier from further consideration. The score label assigned to the input candidate architecture is a prediction of how well the input candidate architecture would perform on the proxy task. If the score label assigned to the input candidate architecture exceeds a threshold (e.g., the input candidate architecture would likely perform well on the proxy task), the input candidate architecture is accepted by the classifier for further consideration. If the score label does not exceed the threshold (e.g., the input candidate architecture would likely not perform well on the proxy task), the input candidate architecture is rejected by the classifier from further consideration.

To determine the final architecture for the neural network, the system repeatedly performs step 204-214 as follows.

The system samples, from a search space defining a plurality of possible architectures for the , a batch of candidate architectures for the neural network for performing the particular neural network task (step 204). For example, the system can randomly sample the batch of the candidate architectures 106 in accordance to a probability distribution.

For each candidate architecture in the batch, the system determines whether the candidate architecture is accepted by all of the classifiers in the sequence of classifiers (step 206).

If the candidate architecture is rejected by one of the classifiers in the sequence, the system rejects the candidate architecture. If the candidate architecture is accepted by all of the classifiers in the sequence, the system adds the candidate architecture to a surviving set of candidate architectures (step 208).

Once the batch of candidate architectures have been evaluated by the sequence of classifiers, the system determines if the current number of classifiers in the sequence has reached a maximum number of P classifiers allowed in the sequence. If P has not been reached, the system initializes a new classifier (step 210).

The system then trains the new classifier using the candidate architectures in the surviving set that were accepted by all of the previous classifiers (step 212).

In particular, to train the new classifier, the system determines, for each candidate architecture in the surviving set of candidate architectures, a respective proxy performance metric of the candidate architecture on the proxy task. Because the proxy task is correlated to the real neural network task, the respective proxy performance metric of the candidate architecture on the proxy task approximates a performance metric of the candidate architecture on the real neural network task. The system then determines, based on the proxy performance metrics of the candidate architectures, a respective score label for each candidate architecture in the surviving set of candidate architectures. The system trains the new classifier on a classifier training dataset that includes: (i) the surviving set of candidate architectures, and (ii) a respective score label assigned to each candidate architecture in the surviving set. In some implementations, the system trains the new classifier using the gradient boosted trees training method. In some other implementations, the system trains the new classifier using a random forests method.

Once the new classifier has been trained, the system adds the new classifier to the sequence of classifiers as the final classifier (step 214). The system resets the surviving set of architectures to null. The new classifier is used along with the previous classifiers in the sequence to evaluate the next batch of candidate architectures.

The system repeats the above steps 204-214 until a maximum number of P classifiers allowed in the sequence is reached. For example, P can be 15, 18, 20, or 25. After P classifiers have been trained and added to the sequence, the system keeps the sequence of classifiers fixed and uses this sequence of classifiers to evaluate newly sampled candidate architectures until the number of candidate architectures sampled from the search space and evaluated by the cascade reaches a predetermined threshold number B. For example, B can be 200, 400, 1600, or 8000.

In some implementations, to ensure that classifiers with low-accuracy are not used, before initiating and training a new classifier, the system determines a respective k-fold cross validation accuracy for each of k independent classifiers (i.e., classifiers that are only used for computing k-fold cross validation accuracy) on the classifier training dataset. The system then determines whether the mean k-fold cross validation accuracy of the k independent classifiers exceeds an accuracy threshold. The system only trains the new classifier on the entire classifier training dataset when the mean k-fold cross validation accuracy of the k classifiers exceeds the accuracy threshold. For example, the system only trains the new classifier if the mean 5-fold cross validation accuracy of 5 independent classifiers on the classifier training dataset is at least 0.5.

If the mean value does not exceed the accuracy threshold, the system stores the classifier training dataset. When a new batch of surviving candidate architectures arrives, the system adds the new surviving candidate architectures and their respective score labels to the dataset and performs the same procedure above.

In some implementations where a parallel budget of W workers are used for evaluating candidate architectures, to accommodate the parallel budget of W workers, the system only trains the new classifier on the training data when the number of candidate architectures in the surviving set exceeds a minimum number of architectures T_{c}. The minimum number of architectures T_{c} can be defined by

$${T}_{c} = W [ \frac{B}{W ( K + 1 )} ] .$$

After the number of candidate architectures sampled from the search space and evaluated by the sequence of classifier reaches a predetermined threshold number B, the system selects a candidate architecture from the surviving set of candidate architectures as the final architecture for the neural network for performing the particular neural network task (step 216).

In particular, the system selects, from the surviving set of candidate architectures, P candidate architectures having highest proxy performance metrics on the proxy task. The system determines, for each of the P candidate architectures, a respective performance metric of the candidate architecture on the particular neural network task. The system selects the candidate architecture having the highest performance metric as the final architecture.

FIG. 3 is a flow diagram of an example process for training a new classifier. For convenience, the process 300 will be described as being performed by a system of one or more computers located in one or more locations. For example, a neural network architecture search system, e.g., the neural network architecture search system 100 of FIG. 1, appropriately programmed in accordance with this specification, can perform the process 300.

The system initializes a new classifier (step 302). For example, the system initializes values of the parameters of the new classifier using random numbers. As another example, the system can set the values of parameters of the new classifier to zeros.

The system determines, for each candidate architecture in the surviving set of candidate architectures, a respective proxy performance metric of the candidate architecture on the proxy task (step 304). Specifically, using the proxy training dataset, the system can train a neural network having the given candidate architecture on the proxy task and then evaluate performance of the trained neural network on the proxy task to determine a performance metric for the given candidate architecture.

The system determines, based on the proxy performance metrics of the candidate architectures, a respective score label for each candidate architecture in the surviving set of candidate architectures (step 306). For example, the system can determine a median value of the proxy performance metrics of all candidate architectures in the surviving set. The system can assign a positive label (+1) to candidate architectures that have proxy performance metrics equal to or above the median value and assign a negative label (−1) to candidate architectures that have proxy performance metrics below the median value.

The system trains the new classifier on the training data including (i) the surviving set of candidate architectures, and (ii) a respective score label for each candidate architecture in the surviving set of candidate architectures (step 308).

In some implementations, the system trains the new classifier using the gradient boosted trees training method. In some other implementations, the system trains the new classifier using a random forests method.

The system adds the new trained classifier to the sequence of classifiers (step 310).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of determining a final architecture for a neural network for performing a particular neural network task, the method comprising:
maintaining a sequence of classifiers, wherein each classifier in the sequence has been trained to process an input candidate architecture and to assign a score label to the input candidate architecture that defines whether the input candidate architecture is accepted or rejected from further consideration;
repeatedly performing the following operations:
sampling, from a search space defining a plurality of architectures, a batch of candidate architectures for the neural network for performing the particular neural network task;
for each candidate architecture in the batch:
determining whether the candidate architecture is accepted by all of the classifiers in the sequence of classifiers;
in response to a determination that the candidate architecture is accepted by all of the classifiers, adding the candidate architecture to a surviving set of candidate architectures; and
selecting a candidate architecture from the surviving set of candidate architectures as the final architecture for the neural network for performing the particular neural network task.

2. The method of claim 1, wherein the sequence of classifiers are trained to assign score labels that indicate that input candidate architectures having high proxy performance metrics on a proxy task are accepted and input candidate architectures having low proxy performance metrics on the proxy task are rejected from further consideration.

3. The method of claim 2, wherein selecting the candidate architecture from the surviving set of candidate architecture as the final architecture comprises:
selecting, from the surviving set of candidate architectures, N candidate architectures having highest proxy performance metrics on the proxy task;
determining, for each of the N candidate architectures, a respective performance metric of the candidate architecture on the particular neural network task; and
selecting the candidate architecture having a highest performance metric as the final architecture.

4. The method of claim 1, wherein repeatedly performing the operations comprises: repeatedly performing the operations until the number of candidate architectures sampled from the search space reaches a first predetermined threshold number.

5. The method of claim 1, wherein repeatedly performing the operations comprises: repeatedly performing the operations until the number of candidate architectures in the surviving set of candidate architectures reaches a second predetermined threshold number.

6. The method of claim 1, wherein sampling, from the search space, the candidate architecture for the neural network for performing the particular neural network task comprises: randomly sampling, from the search space, the candidate architecture for the neural network for performing the particular neural network task.

7. The method of claim 1, wherein the score label is a binary score label.

8. The method of claim 1, wherein repeatedly performing the operations further comprises:
initializing a new classifier;
determining, for each candidate architecture in the surviving set of candidate architectures, a respective proxy performance metric of the candidate architecture on the proxy task;
determining, based on the proxy performance metrics of the candidate architectures, a respective score label for each candidate architecture in the surviving set of candidate architectures;
training the new classifier on the training data including (i) the surviving set of candidate architectures, and (ii) a respective score label for each candidate architecture in the surviving set of candidate architectures; and
adding the new classifier to the sequence of classifiers.

9. The method of claim 8, further comprising:
determining a k-fold cross validation accuracy of k classifiers on the training data;
determining whether the k-fold cross validation accuracy of the k classifiers exceeds an accuracy threshold; and
only training the new classifier on the training data when the k-fold cross validation accuracy exceeds the accuracy threshold.

10. The method of claim 9, further comprising:
only training the new classifier on the training data when the k-fold cross validation accuracy exceeds the accuracy threshold and when the number of candidate architectures in the surviving set exceeds a threshold number.

11. The method of claim 9, wherein k is a predetermined integer.

12. The method of claim 8, wherein determining, based on the proxy performance metrics of the candidate architectures, a respective score label for each candidate architecture in the surviving set of candidate architectures comprises:
determining a median value of the proxy performance metrics of the candidate architectures in the surviving set of candidate architectures; and
comparing the proxy performance metric of the current candidate architecture with the median value to determine the respective score label for the current candidate architecture.

13. The method of claim 12, wherein comparing the proxy performance metric of the current candidate architecture with the median value to determine the respective score label for the current candidate architecture comprises:
when the proxy performance metric of the current candidate architecture is below the median value, assigning a negative score label to the current candidate architecture; and
when the proxy performance metric of the current candidate architecture is equal or above the median value, assigning a positive score label to the current architecture.

14. The method of claim 8, wherein training the new classifier comprises:
training the new classifier using a gradient boosted trees method.

15. The method of claim 8, wherein the respective proxy performance metric of each candidate architecture on the proxy task approximates a performance metric of the candidate architecture on the particular neural network task.

16. A system comprising one or more computers and one or more storage devices storing instructions that, when executed by the one or more computers, cause the one or more computers to perform operations comprising:
maintaining a sequence of classifiers, wherein each classifier in the sequence has been trained to process an input candidate architecture and to assign a score label to the input candidate architecture that defines whether the input candidate architecture is accepted or rejected from further consideration;
repeatedly performing the following operations:
sampling, from a search space defining a plurality of architectures, a batch of candidate architectures for the neural network for performing the particular neural network task;
for each candidate architecture in the batch:
determining whether the candidate architecture is accepted by all of the classifiers in the sequence of classifiers;
in response to a determination that the candidate architecture is accepted by all of the classifiers, adding the candidate architecture to a surviving set of candidate architectures; and
selecting a candidate architecture from the surviving set of candidate architectures as the final architecture for the neural network for performing the particular neural network task.

17. The system of claim 16, wherein repeatedly performing the operations further comprises:
initializing a new classifier;
determining, for each candidate architecture in the surviving set of candidate architectures, a respective proxy performance metric of the candidate architecture on the proxy task;
determining, based on the proxy performance metrics of the candidate architectures, a respective score label for each candidate architecture in the surviving set of candidate architectures;
training the new classifier on the training data including (i) the surviving set of candidate architectures, and (ii) a respective score label for each candidate architecture in the surviving set of candidate architectures; and
adding the new classifier to the sequence of classifiers.

18. The system of claim 17, wherein the operations further comprise:
determining a k-fold cross validation accuracy of k classifiers on the training data;
determining whether the k-fold cross validation accuracy of the k classifiers exceeds an accuracy threshold; and
only training the new classifier on the training data when the k-fold cross validation accuracy exceeds the accuracy threshold.

19. The system of claim 18, wherein the operations further comprise:
only training the new classifier on the training data when the k-fold cross validation accuracy exceeds the accuracy threshold and when the number of candidate architectures in the surviving set exceeds a threshold number.

20. One or more non-transitory computer storage media storing instructions that, when executed by one or more computers, cause the one or more computers to perform operations comprising:
maintaining a sequence of classifiers, wherein each classifier in the sequence has been trained to process an input candidate architecture and to assign a score label to the input candidate architecture that defines whether the input candidate architecture is accepted or rejected from further consideration;
repeatedly performing the following operations:
sampling, from a search space defining a plurality of architectures, a batch of candidate architectures for the neural network for performing the particular neural network task;
for each candidate architecture in the batch:
determining whether the candidate architecture is accepted by all of the classifiers in the sequence of classifiers;
in response to a determination that the candidate architecture is accepted by all of the classifiers, adding the candidate architecture to a surviving set of candidate architectures; and
selecting a candidate architecture from the surviving set of candidate architectures as the final architecture for the neural network for performing the particular neural network task.
